(19) United States
(12) Patent Application Publication
(10) Pub. No.: US 2025/0138874 A1
(43) Pub. Date: May 1, 2025

(54) Exploiting Intra-Process And Inter-Process Parallelism To Accelerate In-Memory Processing Of Graph Queries In Relational Databases

(71) Applicant: Oracle International Corporation, Redwood Shores, CA (US)

(72) Inventors: Ioannis Alagiannis, Zurich (CH); Vlad Ioan Haprian, Zurich (CH); Laurent Phillipe Daynes, Saint-Ismier (FR); Willibrord van Leeuwen, Zurich (CH); Jan Kleine, Zurich (CH); Sungpack Hong, Palo Alto, CA (US)

(21) Appl. No.: 18/384,743

(22) Filed: Oct. 27, 2023

(51) Int. Cl. G06F 9/48; G06F 16/28

(52) U.S. Cl. CPC G06F 9/4881; G06F 16/284

(57) ABSTRACT

The illustrative embodiments provide techniques that utilizes graph topology information to partition work according to ranges of vertices so that each unit of work can be computed independently by different worker processes (inter-process parallelism). The illustrative embodiments also provide an approach for decomposing the graph neighbor matching operations and the property projection operation into fine-grained configurable size tasks that can be processed independently by threads (intra-process parallelism) without the need for expensive synchronization primitives. For graph neighbor matching operations, a given set of source vertices is split into smaller tasks that are assigned to dedicated threads for processing. Each thread is responsible for computing a number of matching source vertices and propagating them to the next graph match operator for further processing. For property projection operations, the computed graph paths are organized into rows that contain the requested properties for each element of the path (vertices and/or edges).

### FIELD OF THE INVENTION

The present invention relates to techniques to accelerate in-memory processing of graph pattern matching queries inside a single machine relational database system by utilizing intra-process and inter-process parallelism.

### BACKGROUND

Graph data enables a variety of new use cases (e.g., money laundering detection, data provenance, supply chain, machine learning engineering) in many fields (e.g., social networks, fraud detection, bioinformatics). Therefore, efficiently supporting graph query processing is important for data analytics.

Industry solutions follow different approaches when it comes to supporting graph queries (e.g., differences in the data model, data organization, processing model, etc.). For example, there are specialized graph database systems (e.g., Neo4j) designed specifically for connected data (i.e., data stored as nodes and edges connecting them, along with their properties), graph analytics engines (e.g., Oracle PGX.D) that process data outside from the data store (usually a relational database) by exporting the data and loading it into the analytics engine, and relational database management systems (RDBMS) with graph analytic capabilities (e.g., Microsoft SQL Server) built on top of the well-known entity-relationship (ER) model.

Relational databases increasingly allow users to define property graphs from relational tables and to query them using graph pattern matching queries. Most products limit users to define a graph out of a single vertex table and edge table (Microsoft SQL Server, SAP Hana). These graphs are called homogeneous graphs. More advanced systems may define graphs out of multiple vertex and edge tables. For example, one can create a heterogeneous graph out of existing tables in a database by mapping every dimension table to a vertex table and every fact table to an edge table. The only constraint is that vertex tables should have a primary key column and the edge tables should associate foreign keys corresponding to the primary keys into two different/same vertex tables.

Graph querying and pattern matching enable interactive exploration of graphs. Pattern matching refers to finding patterns in the graph that are homomorphic to a target pattern, such as a triangle, for example. In addition to the structural pattern, the user can add projections, filters, etc. Graph queries are a very challenging workload, as they put the focus on edges, i.e., the connections in the data. Therefore, executing graph queries might explore immense amounts of intermediate results and queries can quickly explode in terms of memory usage. Additionally, graph queries exhibit very irregular access patterns with limited memory locality, as the query patterns and the connections in the data dictate the accesses.

At a high level, relational database systems might adopt the following approaches to support efficient graph processing analytics: (a) translate the graph query into a join query and process it with an existing SQL engine, or (b) process the graph query by using a specialized graph index that allows for fast edge traversal while efficiently combining batch depth-first search (DFS) exploration in the same in-memory runtime.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 depicts a high-level overview of an in-memory graph table operator extended to utilize inter-process and intra-process parallelism in accordance with an illustrative embodiment.

FIG. 2 is a flowchart illustrating operation of inter-process parallelism for in-memory processing of graph queries in accordance with an illustrative embodiment.

FIG. 3 illustrates inter-process parallelism for an example graph query in accordance with an illustrative embodiment.

FIG. 4 is a flowchart illustrating operation of intra-process parallelism for in-memory processing of graph queries in accordance with an illustrative embodiment.

FIG. 5 illustrates a level context state transitions in a state machine in accordance with an illustrative embodiment.

FIG. 6 illustrates task matching scheduling within an in-memory graph table operator in accordance with an illustrative embodiment.

FIG. 7 is a block diagram that illustrates a computer system upon which aspects of the illustrative embodiments may be implemented.

FIG. 8 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments provide techniques to accelerate in-memory processing of graph pattern matching queries inside a relational database management system by utilizing inter-process and intra-process parallelism. The techniques describe and implement a way of splitting the computation of graph pattern matching queries into smaller tasks that can be processed independently without the need for expensive blocking synchronization, hence significantly improving the execution time of graph matching queries. The techniques of the illustrative embodiments are built on top of a specialized graph index that allows for fast edge traversal while efficiently combining batch-DFS exploration in the same in-memory runtime.

The illustrative embodiments implement techniques in relational database systems that use a multi-process architecture to provide isolation across sessions and/or parallel workers to avoid a single point of failure. In such an architecture, parallelism can be achieved using lightweight threads, worker processes, or a combination of both lightweight threads and worker processes. In this context, the techniques of the illustrative embodiments exploit worker processes for inter-process parallelism and lightweight threads for intra-process parallelism. The illustrative embodiments introduce parallel capabilities for processing graph queries in relational databases that significantly improve performance and efficiency while maintaining all the advantages of previous solutions.

The illustrative embodiments provide a technique that utilizes graph topology information to partition work according to disjoint ranges of vertices so that each unit of work can be computed independently by different worker processes (inter-process parallelism). The illustrative embodiments also provide an approach for decomposing the graph neighbor matching operations and the property projection operation into fine-grained configurable size tasks that can be processed independently by lightweight threads (intra-process parallelism) without the need for expensive synchronization primitives. The illustrative embodiments also provide a scheduling and execution procedure that achieves workload balance, without introducing additional overhead in the execution time, and allows for exploiting inter-process and intra-process parallelism, either independently or complementarily, according to the available system resource.

For graph neighbor matching operations, a given set of source vertices is split into smaller tasks that are assigned to dedicated lightweight threads for processing. Each lightweight thread is responsible for computing a number of matching source vertices and propagating them to the next graph match operator for further processing. For property projection operations, to project the requested property values, the computed graph paths are organized into rows that contain the requested properties for each element of the path (vertices and/or edges). This operation is split into smaller tasks in which each lightweight thread is assigned a range of result rows to produce.

### Extended In-Memory Graph Table Operator

The techniques of the illustrative embodiments extend the “in-memory graph table” operator to efficiently utilize inter-process and intra-process parallelism, thus enhancing performance of graph queries processed in-memory in an RDBMS. The graph table operator transforms result of a graph pattern matching operation into a table, which will have the same number of rows as the number of subgraphs matching the pattern. The graph table operator can be pipelined with other execution plan operators already existing into the database, thus combining pattern matching with SQL-based querying. The result of the graph table operation can therefore be used by other execution plan operators. The graph table operator computes all paths matching a given target pattern on a given graph and returns a table with number of rows equal to the number of paths matched. The graph table operator includes a sequence of match operators for evaluating a path pattern expression. Each match operator in the sequence of match operators receives as input the result of a previous match operator. Each match operator processes a single hop in a path (e.g., edge to follow+destination). Each match operator is specialized to a specific task. Assembling match operators into a path pattern expression is performed by a path pattern match compiler during query compilation. The entire path pattern expression produces paths according to the target pattern.

The illustrative embodiments introduce new techniques for processing graph match operators in parallel while maintaining all the advantages of the “in-memory graph table” operator (e.g., pipeline friendly execution, small memory footprint, cache locality, or neighbor iterators). The in-memory graph table operator is described in further detail in U.S. application Ser. No. 16/710,740, filed Dec. 11, 2019, entitled “HYBRID IN-MEMORY BFS-DFS APPROACH FOR COMPUTING GRAPH QUERIES AGAINST HOMOGENEOUS GRAPHS INSIDE RELATIONAL DATABASE SYSTEMS,” now U.S. Pat. No. 11,392,624, the entire contents of which are hereby incorporated by reference as if fully set forth herein. The techniques for enhancing performance by utilizing parallelism include properly decomposing graph neighbor matching operators into fine-grained configurable tasks that can be processed independently, scheduling execution of tasks to utilize parallelism (based on the type of resources that are available, i.e., threads and processes), efficiently executing the tasks without additional overhead, and accelerating the construction of the result rows from the graph neighbor matching operations.

To describe the techniques of the illustrative embodiments, the techniques are described herein using terminology relating to the in-memory graph table operator, which is responsible for computing all paths (sequences of vertices/edges that can repeat) matching a given path pattern on a given graph, and the “graph match operator” to refer to the component responsible for computing vertices for a specific hop of a path pattern. The in-memory graph table operator utilizes an in-memory representation (data structure) of a graph that uses a compressed sparse row (CSR) format to process graph queries. The graph match operator is designed to leverage during execution the “neighbor iterators” provided by the in-memory graph topology for traversing from a source vertex table to a destination vertex table via an edge. The neighbor iterators internally utilize the CSR representation and allow for quickly iterating over the neighbors of a source vertex to find the matching neighbor vertices or to check the existence of a neighbor vertex or an edge. The in-memory graph topology is described in further detail in U.S. Application No. 17,162,527, filed Jan. 29, 2021, entitled, “EFFICIENT IDENTIFICATION OF VERTICES AND EDGES FOR GRAPH INDEXES IN AN RDBMS, now U.S. Pat. No. 11,500,868, the entire contents of which are hereby incorporated by reference as if fully set forth herein.

The techniques of the illustrative embodiments also utilize three graph match operators, including the Root Node Match (RNM) operator for finding the first level vertices of a path pattern, the Intermediate Neighbor Match (NM) operator for non-leaf level neighbor matches, and the Leaf Neighbor Match (LNM) operator for matching leaf level vertices and the breadth-first search (BFS) and depth-first search (DFS) neighbor traversal approach.

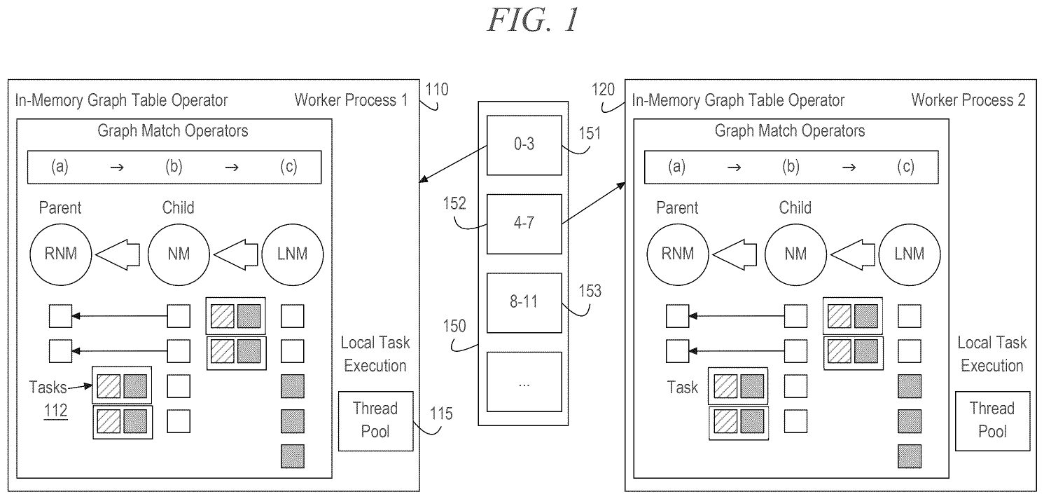

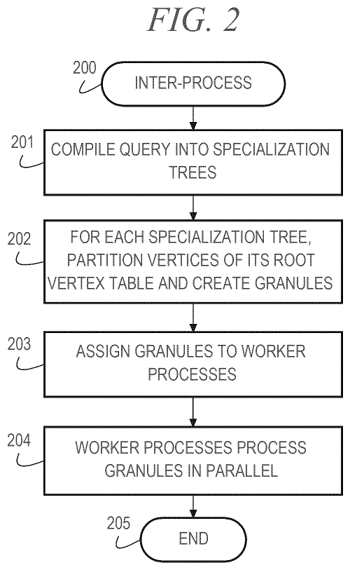

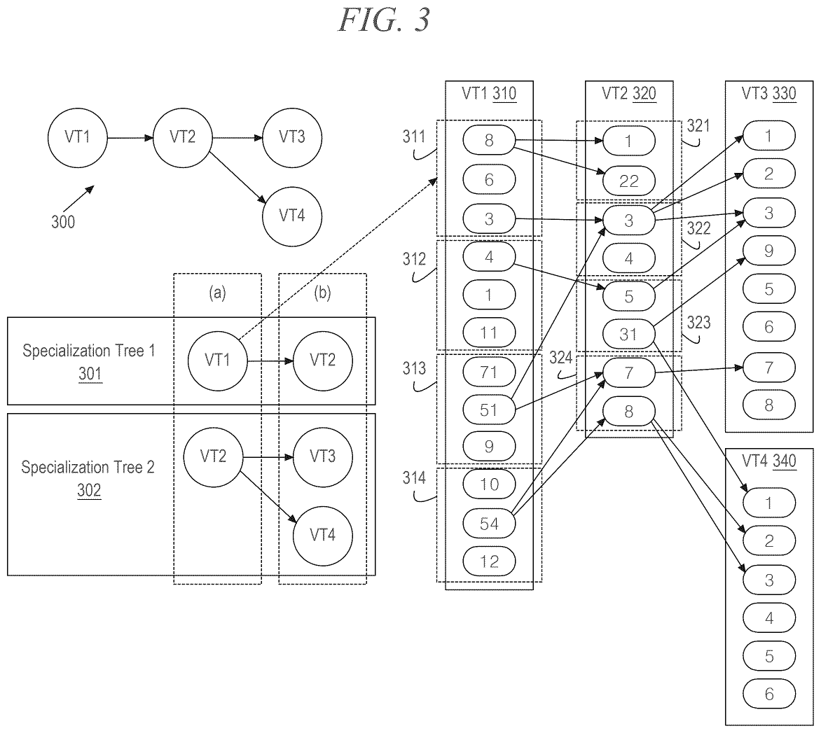

FIG. 1 depicts a high-level overview of an in-memory graph table operator extended to utilize inter-process and intra-process parallelism in accordance with an illustrative embodiment. Inter-process parallelism is demonstrated by the separation of work between different worker processes. As shown in FIG. 1, a vertex source 150 is partitioned into a plurality of work granules 151, 152, 153, each work granules specifying a subset of vertices from the vertex source. The vertex source 150 may be a vertex table, for example. In the depicted example, work granule 151 is assigned to worker process 1 110, and work granule 152 is assigned to worker process 2 120. Each worker process represents an instance of the in-memory graph table operator. The inter-process parallelism is described in further detail below with reference to FIGS. 2 and 3.

Intra-process parallelism is demonstrated by the use of a thread pool, such as thread pool 115 in worker process 110, to speed up the execution of local tasks running within the same worker process. The data structures storing intermediate results of match operators for local tasks are referred to herein as “level contexts.” These level contexts can be used both as input and output depending on the phase of execution and the match operator.

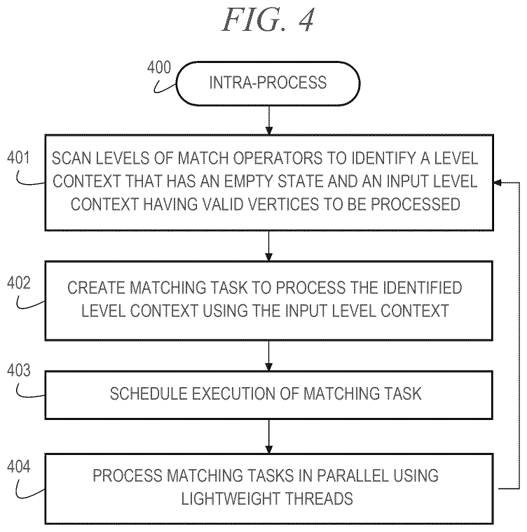

The main operation of the in-memory graph table operator is to compute the paths matching an input path pattern expression on a given graph and project their property values. A path pattern expression is computed using a sequence of graph match operators. Each graph match operator processes a single hop in a path (i.e., source+edge to follow+destination) and consumes the results (if any) of the previous graph match operator (unless it is the first graph match operator, i.e., the root). The first graph match operator of a path expression always consumes the source vertex tables of a graph and computes a number of matching source vertices. Those matching source vertices become the source to the next operator in the path pattern expression, which produces a new set of matching vertices corresponding to that stage (and edges that lead to those vertices). When the last operator is computed its matching vertices, the in-memory graph table operator can produce the entire path match. When one or more paths have been computed, the property values are projected (if any) and the computed rows are returned to the parent operator of the in-memory graph table operator, which then consumes them. The intra-process parallelism is described in further detail below with reference to FIGS. 4-6.

### Inter-Process Parallelism of Matching Operations

The illustrative embodiments extend the in-memory graph table operator to efficiently utilize inter-process parallelism. The in-memory graph table operator is extended in the query compilation phase to decide whether a query should be executed with inter-process parallelism or not and to properly prepare the query for parallel execution. The in-memory graph table operator is extended in the generation of independent similar size tasks by utilizing a specialized graph index encoding of the graph topology. The runtime execution of the in-memory graph table operator is extended to compute paths with independent tasks using worker processes.

The inter-process parallelism of the illustrative embodiments can be implemented using a Parallel Query (PQ) framework or any other parallel processing framework that supports inter-process communication between processes and task scheduling using a coordinator process.

FIG. 2 is a flowchart illustrating operation of inter-process parallelism for in-memory processing of graph queries in accordance with an illustrative embodiment. Operation begins when the query compilation phase decides that a query should be executed with inter-process parallelism (block 200), and the compilation phase compiles the query into specialization tree (block 201). For each specialization tree, the compilation phase partitions the vertices of its root vertex table and creates work granules (block 202). The parallel processing framework assigns granules to worker processes (block 203), and the worker processes process the granules in parallel (block 204). Thereafter, operation ends (block 205).

FIG. 3 illustrates inter-process parallelism for an example graph query in accordance with an illustrative embodiment. The example query assumes graph schema 300 and an instance of the schema including vertex table 1 (VT1) 310, vertex table 2 (VT2) 320, vertex table 3 (VT3) 330, and vertex table 4 (VT4) 340. The values shown in the vertices are identifiers from the vertex tables, not the in-memory graph identifiers (IMGIDs) from the Compressed Sparse Row (CSR). The arrows depict edges in the example graph instance. For example, there are two edges starting from the identifier with value 8 in VT1 310 and ending at the identifiers with values 1 and 22 in VT2 320. As another example, there are two edges starting from the identifier with value 31 in VT2 320 and ending at the identifiers with value 9 in VT3 330 and value 1 in VT4 340.

The example query is a SQL/PGQ query as follows:

```
SELECT *
FROM GRAPH_TABLE(TEST_GRAPH_PQ
    MATCH (a) − [e1] −> (b)
    COLUMNS (a.id as srcId, b.id as dstId)
  ) GT;
```

This query when executed in-memory is compiled into two specialization trees. The first specialization tree 301 computes paths from VT1 310 to VT2 320 while the second specialization tree 302 computes paths from VT2 320 to VT3 330 and VT2 320 to VT4 340.

For each of the specialization trees in this example, granules (units of work) are created by partitioning the vertices of its root vertex table (VT1 310 and VT2 320 respectively). The example created granules are shown as 311-314 for VT1 310 because VT1 is the root vertex table for specialization tree 1 301, and 321-324 for VT2 320 because VT2 is the root vertex table for specialization tree 2 302. Each granule 311-314 and 321-324 specifies a range of vertices from a source table to be processed (expanded into paths matching the query pattern).

The size of each granule is configurable. In this example, the granule is set to three for VT1 310 and to two for VT2 320 for presentation purposes. A worker process executing the granule 311 of the first specialization tree 301 will produce three paths: {(8, 1), (8, 22}, (3, 3)}. Each worker process creating matching paths can also utilize intra-process parallelism to speed up path processing as described below.

### Query Compilation

The query compilation phase of the in-memory graph table operator is extended to determine whether a graph query will be processed in parallel (with inter-process parallelism) or not, to compute the degree of parallelism (DoP). The DoP determines the number of worker processes that will be used, i.e., the number of instances of the in-memory graph table operator, and to include information regarding the graph and the specialization trees required to create independent tasks for the worker processes. This is critical for enhancing performance of graph queries while judiciously sharing resources (e.g., central processing unit (CPU) cores) with other queries running concurrently in the system.

To obtain the DoP of the in-memory graph table operator, the graph query is first translated into an equivalent SQL query. Then, the query optimizer is invoked on the equivalent SQL query to generate an optimized parallel execution plan. The DoP is computed according to the input/output, CPU, and memory cost of the query plan generated by the query optimizer. The DoP of the optimized parallel execution plan is used for processing of the in-memory graph table operator. If the computed DoP is larger than one, then instances of the in-memory graph table operator are executed in parallel using a set of worker processes; otherwise, the in-memory graph table operator will be executed serially.

When a graph query is executed in parallel (i.e., DoP>1), the query plan is annotated for parallel execution by including information about the number of root vertex tables, pointers to root vertex tables of the specialization trees, and the property graph. This information is used to generate the granules that will feed the in-memory graph table operator instances in the worker processes.

### Query Execution

The query execution phase of the in-memory graph table operator is also extended to compute paths using granules (units of work). In case of parallel execution, each worker process parses, allocates, and executes its own instance of the in-memory graph table operator.

### Granule Creation

The work granules are created using graph partitioning information aiming at generating independent tasks of similar size to achieve work balance. The work granules are created at execution time. Every work granule contains a range (start vertex and end vertex identifiers) of internal vertex identifiers and a pointer to a vertex table over which this range is defined. The vertex table pointers point to a root vertex table of a specialization tree. The same design can also be applied if the vertices are partitioned by list or hash to generate the work granules.

The number of work granules to be created per root vertex table in the specialization trees is configurable using a parameter. The default value of this parameter might change according to the characteristics of the graph topology to improve load balancing. Each work granule generates a range of vertices from a root vertex table of the specialization trees. In one embodiment, the ranges are computed using the IMGIDs of the CSRs. Specifically, the work granules for a root vertex table are created by dividing the vertices into (almost) equal ranges, such that work granules from the same root vertex table contain roughly the same number of vertices. To calculate the size of the granule ranges, the maximum and minimum IMGIDs of each root vertex table is used, information that is obtained from the CSRs of the in-memory graph topology. If one of the root vertex tables contains only one vertex, then only one work granule will be generated for that vertex table.

### Granule Processing

A worker process executing a granule obtains the paths for the vertices within the range of the vertex table pointed to by the work granule. The worker process only pulls the relevant leaf level match operator nodes and produces results only for the specified granule range over a single vertex table, which is the root of a single specialization tree. This is done cheaply by maintaining a pointer to its root vertex table node in the specialization tree in each vertex table node. The paths computed from a worker process are propagated to the next query operators of the plan (if any).

Each worker process requests a new granule from the coordinator process at fetch time of the in-memory graph table operator when it has finished executing the previous granule and can perform additional work. The new granule will again contain a range over a single root vertex table. The new granule is independent of the previous granule. Therefore, the new granule might activate another specialization tree than the previous granule did, but it will again only activate one specialization tree.

### Intra-Process Parallelism of Matching Operations

The illustrative embodiments extend the in-memory graph table operator to enhance performance by utilizing intra-process parallelism (i.e., threads) when matching neighbors of a given set of source vertices. The operation of matching neighbors of a given set of source vertices is decomposed into smaller tasks that are assigned to dedicated threads for processing. Each task is responsible for computing a number of matching source vertices and propagating them to the next graph match operator for further processing. The work of each task is independent, and no communication is required between threads to synchronize their computation, which allows for processing from multiple threads. The size of each task can be configured by specifying how many neighbors are to be explored for the input parent vertices. This allows for controlling the memory footprint (one of the desired properties of the in-memory graph table operator) while accelerating the matching operations. Each graph match operator maintains a fixed number of level contexts that can be used by the threads for input/output. In practice, a minimum number of level contexts are required to fully utilize the available parallelism.

FIG. 4 is a flowchart illustrating operation of intra-process parallelism for in-memory processing of graph queries in accordance with an illustrative embodiment. Operation begins when the query compilation phase decides that a query should be executed with intra-process parallelism (block 400), and the in-memory graph table operator scans levels of match operators to identify a level context that has an empty state and an input level context having valid vertices to be processed (block 401). The in-memory graph table operator creates a matching task to process the identified level context using the input level context (block 402) and schedules execution of the matching task (block 403). The matching task may be executed by a graph match operator (e.g., Root Node Match (RNM), Intermediate Neighbor Match (NM), or Leaf Neighbor Match (LNM)) or by a property projection operator (not shown). The in-memory graph table operator processes the matching tasks in parallel using lightweight threads (block 404). Thereafter, operation returns to block 401 to scan the levels of the match operators until all level contexts have been fully processed.

A coordinator thread is responsible for identifying the available level contexts for each graph matching operator (i.e., the root, non-leaf, leaf) at a specific level and assigning them as input/output of the matching tasks. A matching task at level i is responsible for matching vertices at level i and it has the following components:
Input: a level context from the level i−1. It is a level context with source vertices from the parent operator ready to be used to find matching vertices. If i is the first level of the path pattern expression, then the task uses as an input a partition of the source vertices from the input source table(s).
Matching function: a function that allows for fetching neighbors of vertices from level i−1 and writes them to level i.
Output: a context at level i, where the matching task writes the matched neighbors.
Task callback: a function to be called on task completion.

As matching paths are constructed by vertices/edges stored in multiple level contexts, each level context at level i is associated with its parent level context at level i−1. Multiple level contexts can have the same parent level context; therefore, a level context keeps a counter to track the number of its children. The counter is necessary to ensure that a level context is not overwritten until all child level contexts for this path have been processed to completion.

### State Machine

The coordinator identifies the level contexts that can be used as input for matching tasks at any level and those that should not be processed. To keep track of the level contexts associated with a graph matching operator and their state, the coordinator utilizes a state machine implemented by a queue backed by linked lists, keeping one linked list per state. The coordinator removes the level contexts from the proper linked list before submitting the task for processing and moves them back int the queue after task execution has been completed. The state machine allows for avoiding the need for explicit synchronization, and it enables the coordinator to quickly select the available level contexts for processing while the threads computing the matching tasks remain completely agnostic to any book-keeping required.

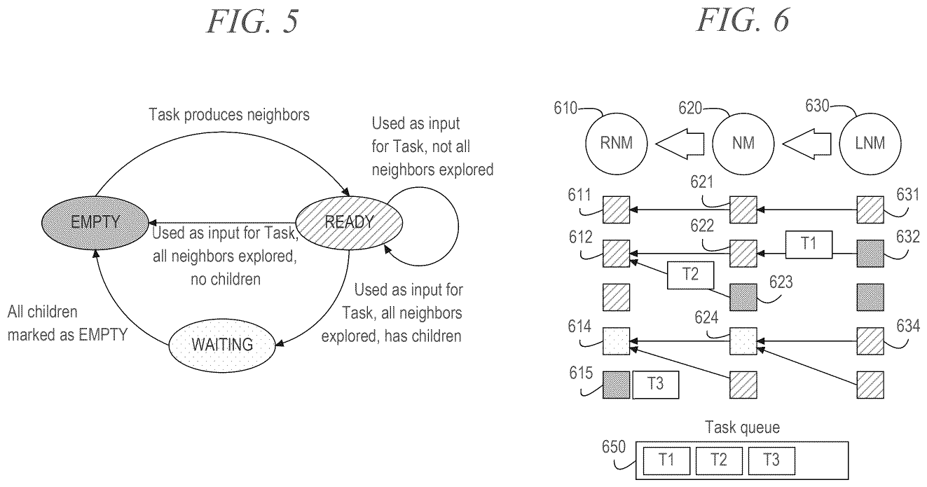

FIG. 5 illustrates a level context state transitions in a state machine in accordance with an illustrative embodiment. A level context can be in one of the following states:

EMPTY: The level context does not hold any valid vertices (that is, vertices that are a match at the given level) and is ready to be filled. This is the initial state after allocation, and the level context can only be used as an output level context for a matching task.

READY: The level context stores valid vertices that have neighbor iterators that are not yet (known to be) exhausted. It can be used as an input level context for a task. When a level context gets its matches from another level context, it becomes a child of this level context. A READY level context can be the parent to multiple child contexts at the same time.

WAITING: The level context has at least one child context, but all neighbor iterators have been exhausted. It can be used as neither an input level context nor an output level context for a task. The data might still be used for constructing the matched paths.

When a level context has been processed, the coordinator utilizes the state machine and transitions it from the EMPTY state to the READY state. Once in the READY state, a level context can be used to fill children. It remains in READY state for as long as it has at least one vertex with a valid neighbor iterator in any specialization. Once all neighbor iterators have been exhausted, the level context either moves to the WAITING state or the EMPTY state, depending on whether it has children or not. A WAITING level context is marked as EMPTY once the child counter is decremented to zero.

### Matching Task Creation

The matching task creation happens at execution time when fetching of matching neighbors of vertices begins and is controlled by the coordinator. The process starts with the root level graph operators. All the path matches have been found once all source vertices have been explored and their matching neighbors have been propagated through the levels up until they have reached the leaf level graph operators. When no more tasks can be produced at a given level (there are no more sources and all preceding graph operators cannot produce any new matching neighbors), that level context is marked as EMPTY.

The following pseudo-code describes the steps at level i:

```
produce_neighbors(i) {
  if (i > 0) {
  for every READY level context in_ctx at level i−1 {
  pick available EMPTY context out_ctx at level i
  if no EMPTY context available
  return
  enqueue task T: {input: in_ctx, output: out_ctx, f: match_neighbors}
  }
  if no more tasks are created and level i−1 is done
  mark this level as done.
  } else if (i == 0) {
  for every EMPTY context out_ctx at level 0
  enqueue task T: {input: src_partition, output: out_ctx, f: match_sources}
  if no more sources to fetch
  mark the level as done.
  }
}
```

### Matching Function

In accordance with illustrative embodiments, there are two types of matching functions: match_neighbors, which matches neighbors of vertices at an intermediate or last level of the query, and match_sources, which matches neighbors of vertices at the first level of the query. The matching functions are executed by the worker threads and rely on neighbor iterators to find the neighbors of a given source vertex (neighbor traversal). These iterators are exposed by the in-memory graph topology.

The following pseudo-code describes both functions:

```
match_neighbors(in_ctx, out_ctx) {
  while out_ctx not full and in_ctx not empty {
  fetch first valid neighbor iterator from in_ctx
  write as many neighbors fit to out_ctx (applying filters if possible)
  if neighbor iterator is exhausted
  mark neighbor iterator nvalid as invalid (exhausted)
  }
  for every vertex in out_ctx
  initialize next neighbor iterators
}
match_sources(src_part, out_ctx) {
  iterate over all source vertices in src_part and apply any filters
  write matching ones to the out_ctx
  for every source fetched
  prepare next neighbor iterators
}
```

### Matching Task Execution Using Threads

The above match sources and match neighbors matching functions are designed to process independent matching tasks, which enables utilizing parallelism. The current architecture assumes a pool of threads. One of the threads has the coordinator role while the rest of the threads are worker threads and compute matching tasks. As mentioned above, the coordinator handles task creation and is responsible for managing level contexts at runtime. It is critical to ensure that a level context cannot be used by two tasks simultaneously (i.e., two tasks cannot have the same in_ctx or out_ctx at the same time). The pool of threads is created at start time of the in-memory graph table operator instance. The exact number of threads granted to the pool is determined by the resource manager, but the user can also specify a desirable number of threads via the runtime parameter (the final number of threads might be lower). The pool persists for the duration of the query and is destroyed when the in-memory graph table operator instance is closed.

### Matching Task Sizing

The design enables a fine-grained task sizing that allows for better work balance across threads. For every matching task, the number of neighbors that a graph operator is going to explore can be tuned. Together with the configurable level context size, tasks can be tuned for different graph types (e.g., power law graphs like social graphs, sparse graphs, regular graphs, etc.) and different execution models. For example, larger tasks can be used to minimize potential thread initialization overheads. The optimizer can utilize available statistics regarding the characteristics of the graph (e.g., the graph density, the average degree of connectivity, the diameter) to decide about the initial task size at compile time. The task size can be potentially adjusted during the query execution based on collected runtime metrics. By adapting the task sizing, the in-memory graph engine can achieve the desired degree of parallelism and optimize the utilization of the available rows by ensuring that level contexts are not too sparse.

The matching tasks can never use more memory than the available statically pre-allocated level contexts, which helps to bound the upper memory footprint of the in-memory graph table operator instance.

### Matching Task Scheduling

The parent of the in-memory graph table operator periodically requests a number of rows (paths). The in-memory graph table operator is then expected to produce the rows, return them to the parent and wait for the next call from the parent. The in-memory graph table operator creates new matching tasks and schedules their execution as part of this process of producing new paths. The following pseudo-code summarizes how the in-memory graph table operator produces new paths:

```
produce_paths ( ) {
  while (true) {
  [1. Return paths computed so far]
  Scan last level and return any completed paths to result row-set
  after all paths from a chain are returned, mark the chain of level
  contexts as EMPTY.
  if result row-set is full or termination == true
  return
  [2. Create/Enqueue more tasks]
  call pull on all last level graph match operators
  [3. Wait for tasks to finish]
  while #tasks in progress > 0 {
  pick a completed task and process callback
  remove task from the queue
  }
  [4. Check termination]
  if all levels are done
  termination = true
  }
}
```

Step 1 of the pseudo-code: When a new request for producing paths is received, the coordinator thread scans the levels backwards (from the last level towards the first level in the query path pattern) to find completed paths that can be returned to the parent SQL row source. After all the paths have been re-constructed from their level contexts on the different levels, their level contexts are marked as EMPTY and can be used again as output level context for a matching task. The process of re-constructing a path and projecting its property values using worker threads is described below. If the row-set to be returned to the parent operator is full or all the paths have been computed, the in-memory graph table operator returns the row-set to the parent.

Step 2 of the pseudo-code: If there are more paths to be computed, the coordinator thread scans the level contexts backwards to find the level contexts that must be processed. Then, it creates new matching tasks to process those level contexts and schedules their execution from worker threads (matching tasks are queued-either match sources or match neighbors matching as described above). On task completion, the operator asynchronously enqueues the expansion for the next level. The backwards-first scanning allows for prioritizing tasks at deeper levels (DFS exploration approach). At any point of execution, the operator can control how many matching tasks are in progress at every level by simply keeping track of how many tasks we submit for every level.

Step 3 of the pseudo-code: Once a matching task has completed a callback is executed, which does the following: marks the output level context as READY or EMPTY, depending on whether neighbors were produced; marks the input level context as EMPTY or WAITING if all neighbors were exhausted, depending on whether neighbors were produced or not (in case of EMPTY, the state is propagated); and, directly chains the next matching task or set of tasks for matching the vertices at the next level, this not requiring the operator to wait for all the tasks at level i to be completed before enqueuing tasks at level i+1.

FIG. 6 illustrates task matching scheduling within an in-memory graph table operator in accordance with an illustrative embodiment. FIG. 6 shows a possible snapshot at a given execution time of graph match operators (RNM 610, NM 620, and LNM 630). The control flow of the in-memory graph table operator is pull-based. Therefore, starting at the leaf level (LNM 630), an EMPTY level context can pull paths to expand from a READY level context at the previous level (NM 620). If a level context at the NM level 620 is also EMPTY, then the level context at that level can pull paths to expand from a READY level context at the previous level (RNM 610). If a level context at the RNM level 610 is empty, then it can pull vertices to match from the granule assigned to the worker process.

In this example, there are two identifiable cases with completed paths that can be returned to the parent SQL row source operator: the first row of level contexts (fully READY path) and the leaf level contexts in the READY state. In the fully READY path case, the graph path has been completed, and the level contexts 611, 621, 631 are marked as READY, store valid vertices, their neighbor iterators have been fully exhausted, and they can be used to reconstruct all the paths from their level contexts on the different levels. Once done, their level contexts 611, 621, 631 will be marked as EMPTY.

In the two cases with READY leaf level contexts and WAITING intermediate level contexts (e.g., the second to last row of level contexts in FIG. 6), the level contexts 614, 624, 634 can again be used to reconstruct all the paths from their level contexts; however, they cannot yet be marked as EMPTY until their stored vertices have been used for all the required path reconstructions. Each level context keeps a counter to track the number of its children, and only when all the children level contexts have been processed to completion can they be moved to the EMPTY state (for this example, the intermediate WAITING NM level context 624 should wait for its two children to be processed). At the same time, they cannot be used as input to a task.

In the same example, the second and third rows of level contexts show two cases in which some paths are asynchronously extended with matching neighbors by enqueueing new matching tasks at different levels. In the depicted example, task T1 uses as input the READY level context 622 with source vertices from the NM level 620 and uses as output the EMPTY level context 632 from the LNM level 630. Similarly, task T2 uses as input the READY level context 612 from the RNM level 610 and uses as output the EMPTY level context 633 from the NM level 620. Also shown in FIG. 6, task T3 uses as input source vertices from the granule assigned to the worker process executing the instance of the in-memory graph table operator and uses as output the EMPTY level context 615. The new matching tasks are submitted to a task queue 650, which is processed by the pool of threads.

### Parallelism of Path Projection

The time spent projecting the property values of the generated paths can account for a significant portion of overall execution time, depending on the number and position of the projected parameters. The illustrative embodiments provide techniques for projecting properties values of the generated paths using worker threads by creating tasks that can be independently processed. At a high level, as long as there are computed paths and not enough rows have been projected, the coordinator thread scans the leaf level operators to find those that have at least one READY level context. Then, it initiates a worker thread to process that level context and to project the property values of all paths ending there. If the level context does not have enough paths to fill the entire row set, the process continues on the next leaf level context/operator. After all the paths have been reconstructed from their level contexts on the different levels, their level contexts are marked as EMPTY, and can be used again as output level context for a matching task.

The worker thread takes as input a leaf level context (in READY state), the range of rows to materialize, and an offset in the output row set to which to write the results. The number of rows assigned to each worker thread can be tuned using a system parameter. The coordinator thread is responsible for generating tasks with non-overlapping ranges of rows; therefore, no synchronization between the worker threads is needed.

The size of the output row set (consumed by the parent SQL operator of the in-memory graph table operator) is important to maximize the benefit from parallelizing the projections. For example, a small row set (e.g., less than 1000) is not enough to parallelize the work of projecting rows using multiple threads, as the overhead of such small tasks vastly out ways the speedup. To overcome this issue, the in-memory graph table operator maintains a larger internal buffer (allocated at query start time on the cursor work-heap) with a configurable size (e.g., one million rows) through a system parameter. This buffer mirrors the layout of the output row set, except with more rows. It is filled by tasks being responsible for materializing the properties for different ranges of rows. In some example implementations, using an internal buffer size of one million rows and a task size of 16 thousand rows may offer good performance and scalability up to sixteen threads. When the parent SQL operator needs a set of rows, the in-memory graph table operator updates the pointers in the row set output structure to point to the correct element in the internal buffer. This ensures minimal performance overhead of creating a new buffer from scratch by avoiding memory copies.

### DBMS Over View

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MongoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

A database object may have an attribute that is a primary key. A primary key contains primary key values. A primary key value uniquely identifies a record among the records in the database object. For example, a database table may include a column that is a primary key. Each row in the database table holds a primary key value that uniquely identifies the row among the rows in the database table.

A database object may have an attribute that is a foreign key of a primary key of another database object. A foreign key of a primary key contains primary key values of the primary key. Thus, a foreign key value in the foreign key uniquely identifies a record in the respective database object of the primary key.

A foreign key constraint based on a primary key may be defined for a foreign key. A DBMS ensures that any value in the foreign key exists in the primary key. A foreign key need not be defined for a foreign key. Instead, a foreign key relationship may be defined for the foreign key. Applications that populate the foreign key are configured to ensure that foreign key values in the foreign key exist in the respective primary. An application may maintain a foreign key in this way even when no foreign relationship is defined for the foreign key.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

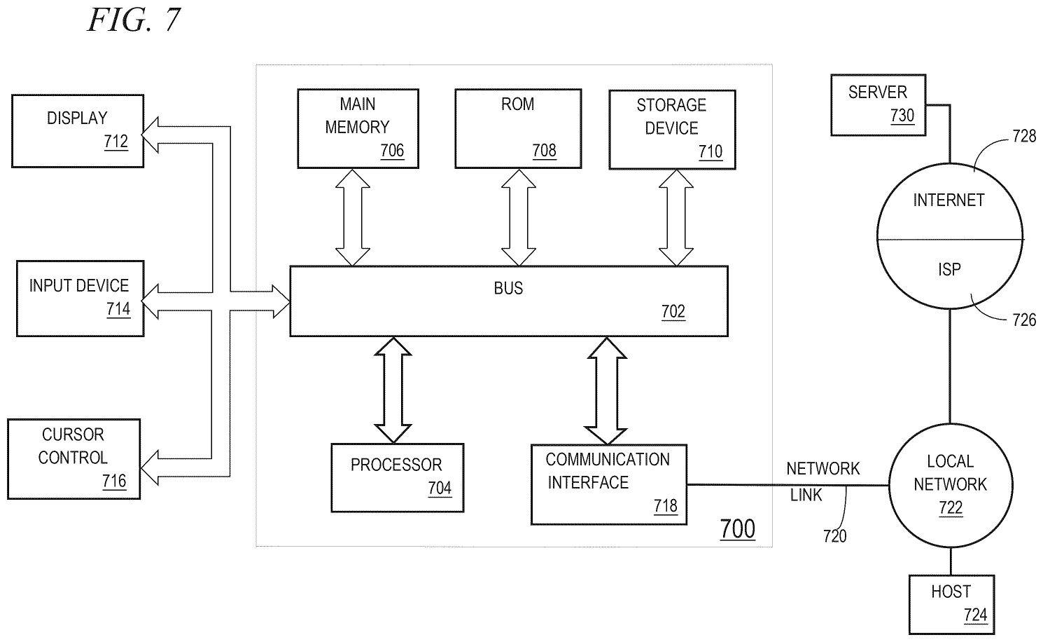

For example, FIG. 7 is a block diagram that illustrates a computer system 700 upon which aspects of the illustrative embodiments may be implemented. Computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world-wide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

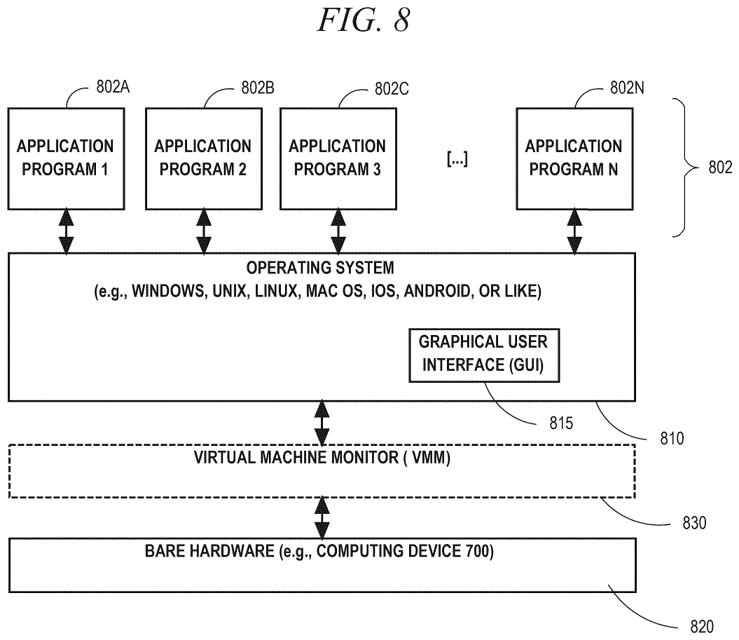

FIG. 8 is a block diagram of a basic software system 800 that may be employed for controlling the operation of computer system 700 upon which aspects of the illustrative embodiments may be implemented. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computer system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 700 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
performing in-memory processing of a pattern matching query for matching a path pattern on a graph, wherein:
the graph is stored one or more vertex tables and one or more edge data structures, performing the in-memory processing of the pattern matching query comprises:
partitioning vertices of a graph table row source into a plurality of granules of work; and
executing the plurality of granules of work on a plurality of worker processes using inter-process parallelism,
executing each given granule of work on a given worker process comprises:
decomposing graph neighbor matching operations into a plurality of tasks that can be processed independently; and
scheduling execution of the plurality of tasks on a plurality of threads from a pool of threads using intra-process parallelism;
wherein the method is performed by one or more computing devices.

2. The method of claim 1, wherein partitioning the vertices into the plurality of granules of work comprises:
compiling the pattern matching query into one or more specialization trees;
for each of the one or more specialization trees:
partitioning vertices of a root vertex table of the specialization tree into one or more granules of work; and
executing the one or more granules of work on one or more worker processes, wherein each worker process in the one or more worker processes creates a result set of matching paths for the specialization tree.

3. The method of claim 2, wherein each granule of work has an associated range of internal vertex identifiers and a pointer to a vertex table over which a range of internal vertex identifiers is defined.

4. The method of claim 3, wherein the pointer to the vertex table references a root vertex table of a specialization tree.

5. The method of claim 1, wherein each task within the plurality of tasks is associated with a graph match operator comprising one of:
a root vertex match (RM) operator for finding a first level of vertices of the path pattern,
an intermediate neighbor match (NM) operator for finding non-leaf neighbor matches of the path pattern, or
a leaf neighbor match (LNM) operator for finding leaf level vertices matching the path pattern.

6. The method of claim 1, wherein each task within the plurality of tasks is associated with a graph match operator that maintains one or more level contexts that can be used for input or output.

7. The method of claim 6, wherein each level context has an associated state comprising one of:
an empty state indicating the level context does not hold any valid vertices and is ready to be filled,
a ready state indicating the level context stores valid vertices that have neighbor iterators, or
a waiting state indicating the level context has at least one child context but all neighbor iterators have been exhausted.

8. The method of claim 7, wherein decomposing graph neighbor matching operations comprises:
scanning levels of the graph neighbor matching operations backwards;
identifying a level context that has an empty state and an input level context with valid vertices to be processed;
creating a matching task to process the identified level context using the input level context; and
scheduling execution of the matching task.

9. The method of claim 8, wherein decomposing graph neighbor matching operations further comprises:
in response to completing execution of the matching task:
marking an output level context of the matching task as ready if one or more neighbors were produced or empty if no neighbors were produced;
marking the input level context as empty if the input level context does not have another child context or waiting if the input level context has another child context; and
scheduling a next set of matching tasks at a next level of the graph neighbor matching operations.

10. The method of claim 6, wherein executing each given granule of work on the given worker process comprises:
scanning leaf level graph match operators to identify a particular level context having valid vertices;
projecting property values of all paths ending at the particular level context into an output row set; and
marking the particular level context as empty.

11. The method of claim 1, wherein:
the pool of threads comprises a coordinator thread and a plurality of worker threads, and
the coordinator thread performs task creation, manages level contexts, and assigns the plurality of tasks to the plurality of worker threads.

12. The method of claim 1, wherein each worker process within the plurality of worker processes requests a new granule of work from a coordinator process after completing execution of a previous granule of work.

13. One or more non-transitory storage media storing instructions which, when executed by one or more computing devices, cause:
performing in-memory processing of a pattern matching query for matching a path pattern on a graph, wherein:
the graph is stored one or more vertex tables and one or more edge data structures, performing the in-memory processing of the pattern matching query comprises:
partitioning vertices of a graph table row source into a plurality of granules of work; and
executing the plurality of granules of work on a plurality of worker processes using inter-process parallelism,
executing each given granule of work on a given worker process comprises:
decomposing graph neighbor matching operations into a plurality of tasks that can be processed independently; and
scheduling execution of the plurality of tasks on a plurality of threads from a pool of threads using intra-process parallelism.

14. The one or more non-transitory storage media of claim 13, wherein partitioning the vertices into the plurality of granules of work comprises:
compiling the pattern matching query into one or more specialization trees;
for each of the one or more specialization trees:
partitioning vertices of a root vertex table of the specialization tree into one or more granules of work; and
executing the one or more granules of work on one or more worker processes, wherein each worker process in the one or more worker processes creates a result set of matching paths for the specialization tree.

15. The one or more non-transitory storage media of claim 13, wherein each task within the plurality of tasks is associated with a graph match operator comprising one of:
a root vertex match (RM) operator for finding a first level of vertices of the path pattern,
an intermediate neighbor match (NM) operator for finding non-leaf neighbor matches of the path pattern, or
a leaf neighbor match (LNM) operator for finding leaf level vertices matching the path pattern.

16. The one or more non-transitory storage media of claim 13, wherein each task within the plurality of tasks is associated with a graph match operator that maintains one or more level contexts that can be used for input or output.

17. The one or more non-transitory storage media of claim 16, wherein each level context has an associated state comprising one of:
an empty state indicating the level context does not hold any valid vertices and is ready to be filled,
a ready state indicating the level context stores valid vertices that have neighbor iterators, or
a waiting state indicating the level context has at least one child context but all neighbor iterators have been exhausted.

18. The one or more non-transitory storage media of claim 17, wherein decomposing graph neighbor matching operations comprises:
scanning levels of the graph neighbor matching operations backwards;
identifying a level context that has an empty state and an input level context with valid vertices to be processed;
creating a matching task to process the identified level context using the input level context; and
scheduling execution of the matching task.

19. The one or more non-transitory storage media of claim 16, wherein executing each given granule of work on the given worker process comprises:
scanning leaf level graph match operators to identify a particular level context having valid vertices;
projecting property values of all paths ending at the particular level context into an output row set; and
marking the particular level context as empty.

20. The one or more non-transitory storage media of claim 13, wherein:
the pool of threads comprises a coordinator thread and a plurality of worker threads, and
the coordinator thread performs task creation, manages level contexts, and assigns the plurality of tasks to the plurality of worker threads.
